(19) United States
(12) Patent Application Publication
(10) Pub. No.: US 2009/0297856 A1
(43) Pub. Date: Dec. 3, 2009

(54) Adhesion promoter composition comprising epoxy resin

(75) Inventors: Reto Dohner, Zurich (CH); Michael Schlumpf, Stallikon (CH); Andreas Diener, Wald (CH); Wolf-Rudiger Huck, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/453,342

(22) Filed: May 7, 2009

(30) Foreign Application Priority Data
May 28, 2008 (EP) 08157103.6

(51) Int. Cl. B32B 27/38; C08L 63/00; B32B 37/12

(52) U.S. Cl. 428/414; 525/523; 156/60

(57) ABSTRACT

The present invention provides compositions comprising at least one reaction product obtained from a reaction mixture comprising i) at least one mercaptosilane MS, and also ii) at least one polysilane PS which contains in particular at least one secondary or tertiary amino group, preferably a secondary amino group, and also iii) at least one epoxy resin EP.

The compositions are suitable as adhesion promoters, more particularly in the form of primers. They exhibit good adhesion and are especially suitable for the adhesive bonding of glass and glass ceramic.

### TECHNICAL FIELD

The present invention relates to the field of adhesion promoters.

### PRIOR ART

Adhesive bonding is a widely used joining technology. In view of the large number of possible substrates which are bonded to one another, there are always substrates which with certain adhesives are unable to develop any adhesion or any adequate adhesion. In order to improve the adhesion of adhesives and sealants on these substrates, the use of adhesion promoters, especially primers, has been practised for some considerable time.

Adhesion promoters used are typically silanes, in many cases in the form of mixtures. However, the adhesion promoters disclosed in the prior art frequently have adhesion problems, particularly on glass and glass ceramics and especially after water storage.

### SUMMARY OF THE INVENTION

It is an object of the present invention, therefore, to provide adhesion promoters which exhibit good adhesion of one-component, moisture-curing polyurethane adhesions, particularly to glass and glass ceramics, and especially after water storage.

Surprisingly it has now been found that the compositions according to claim 1 are able to achieve this object.

The compositions are suitable more particularly as primers for one-component moisture-curing polyurethane adhesives and are used advantageously for the bonding of glass and glass ceramic. They have shown particularly suitability in use as primers for the glazing of means of transport, particularly of road and rail vehicles.

Further advantageous embodiments of the invention are subject matter of further independent and dependent claims.

### EMBODIMENTS OF THE INVENTION

The present invention provides compositions comprising at least one reaction product obtained from a reaction mixture comprising:
i) at least one mercaptosilane MS;
and
ii) at least one polysilane PS which in particular contains at least one secondary or tertiary amino group, preferably a secondary amino group;
and
iii) at least one epoxy resin EP.

The term “organoalkoxysilane”, or “organoacyloxysilane”, or “silane” for short refers in the present document to compounds which on the one hand contain at least one, typically 2 or 3, alkoxy groups, or acyloxy groups, attached directly to the silicon atom (via an Si—O bond) and which on the other hand have at least one organic radical attached to the silicon atom (via an Si—C bond) and have no Si—O—Si bonds. Accordingly, the term “silane group” refers to the silicon-containing group that is attached to the organic radical of the organoalkoxysilane or organoacyloxysilane, respectively. The organoalkoxysilanes or organoacyloxysilanes, and their silane groups, have the property of undergoing hydrolysis on contact with moisture. This forms organosilanols, which are organosilicon compounds containing one or more silanol groups (Si—OH groups) and, as a result of subsequent condensation reactions, forms organosiloxanes, in other words organosilicon compounds containing one or more siloxane groups (Si—O—Si groups).

Silanes which have amino, mercapto and/or oxirane groups in the organic radical attached to the silicon atom of the silane group are referred to as “aminosilanes”, “mercaptosilanes” and “epoxysilanes”, respectively. A primary aminosilane contains a primary amino group —NH₂. A secondary aminosilane contains a secondary amino group —NH—. A tertiary aminosilane contains a tertiary amino group

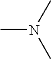

Substance names beginning with “poly”, such as polysilane, polyol, polyisocyanate, polymercaptan or polyamine, refer in the present document to substances which formally contain 2 or more per molecule of the functional groups that occur in their name.

In this document, the use of the term “independently of one another” in connection with substituents, radicals or groups is to be interpreted to mean that in the same molecule the substituents, radicals or groups so identified may occur simultaneously with different definitions.

Epoxy resins EP suitable for preparing the reaction mixture are, in particular, epoxy resins of the formula (I).

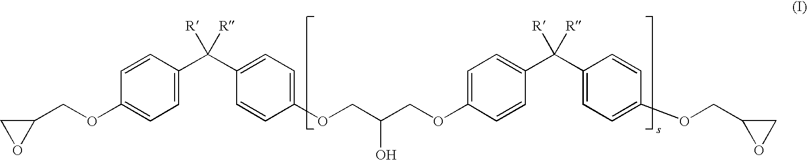

In this formula, the substituents R′ and R″ independently of one another are either H or CH₃. The index s stands for a value from 0 to 20.

Compounds of the formula (I) with an index s of >1.5, more particularly of 2 to 12, are referred to as solid epoxy resins. Solid epoxy resins of this kind are available commercially, for example, from Dow Chemical or Huntsman or Hexion, in the form for example of D.E.R.™ 671 or D.E.R.™ 692 (Dow) or Araldite® GT 7071 (Huntsman).

Compounds of the formula (I) having an index s of between 1 and 1.5 are referred to by the person skilled in the art as semisolid epoxy resins. For the present invention here they are likewise considered to be solid epoxy resins. Preference, however, is given to solid epoxy resins in the narrower sense, i.e. where the index s has a value of >1.5. The term “solid epoxy resin” is very well known to the person skilled in the epoxy art and is used in contrast to “liquid epoxy resins”. The glass transition temperature of solid epoxy resins is above room temperature, i.e. they can be comminuted at room temperature to pourable powders or granules.

Compounds of the formula (I) having an index s of between 0 to 1 are referred to as liquid epoxy resins. Preferably s stands for a value of less than 0.2.

The compounds in question are therefore, for example, diglycidyl ethers of bisphenol A (DGEBA), of bisphenol F and of bisphenol A/F (the designation ‘A/F’ refers here to a mixture of acetone with formaldehyde that is used as a reactant in its preparation). Liquid epoxy resins of this kind are available in the form, for example, of Araldite® GY 250, Araldite® PY 304 and Araldite® GY 282 (Huntsman) or D.E.R.™ 331 or D.E.R.™ 336 (Dow) or D.E.R.™ 330 (Dow) or Epikote 828 (Hexion).

Additionally suitable as epoxy resin EP are what are known as novolaks. These have in particular the following formula:

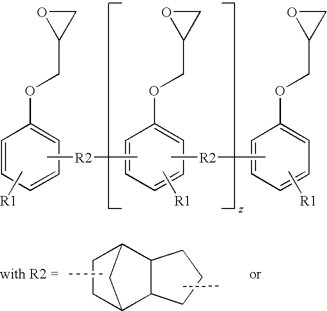

CH₂, R1=H or methyl and z=0 to 7. The dashed lines in the formulae in this document represent in each case the bond between the respective substituent and the remainder of the associated molecule.

In particular these are phenol or cresol novolaks (R2=CH₂).

Novolaks of this kind are available commercially under the trade name EPN or ECN and also Tactix® from Huntsman or as members of the product series D.E.N™ from Dow Chemical.

The epoxy resin EP is preferably a solid epoxy resin of the formula (I) having an index s of >1.5, in particular of 2 to 12.

It is further of advantage if the epoxy resin EP has an epoxide equivalent weight (EEW) of 300 g/eq-2000 g/eq, in particular 400 g/eq-1000 g/eq.

The weight fraction of the epoxy resin EP used in the reaction mixture is advantageously 15%-70% by weight, in particular of 20%-60% by weight, preferably 30%-50% by weight, based on the weight of the reaction mixture.

Mercaptosilanes MS suitable for preparing the reaction mixture preferably have the formula (II).

HS—R¹—Si(OR²)_{(3-c)}(R³)_{c} (II)

In this formula R² independently at each occurrence is an alkyl group having 1 to 4 C atoms or an acyl group having 1 to 4 C atoms, preferably methyl. Additionally, R³ independently at each occurrence is H or an alkyl group having 1 to 10 C atoms, and R¹ is a linear or branched alkylene group having 1 to 6 C atoms, especially propylene, and c stands for a value of 0, 1 or 2, preferably 0.

Particularly suitable mercaptosilanes MS are mercaptosilanes selected from the group consisting of mercaptomethyltrimethoxysilane, mercaptomethyltriethoxysilane, mercaptomethyldimethoxymethylsilane, mercaptomethyldiethoxymethylsilane, 3-mercaptopropyltrimethoxysilane, 3-mercaptopropyltriethoxysilane, 3-mercaptopropyltriisopropoxysilane, 3-mercaptopropylmethoxy(1,2-ethylenedioxy)silane, 3-mercaptopropylmethoxy(1,2-propylenedioxy)silane, 3-mercaptopropylethoxy(1,2-propylenedioxy)silane, 3-mercaptopropyldimethoxymethylsilane, 3-mercaptopropyldiethoxymethylsilane, 3-mercapto-2-methylpropyltrimethoxysilane and 4-mercapto-3,3-dimethylbutyltrimethoxysilane.

Preferred mercaptosilanes MS are 3-mercaptopropyltrimethoxysilane and 3-mercaptopropyltriethoxysilane, especially 3-mercaptopropyltrimethoxysilane.

A suitable polysilane PS in a first embodiment is a polysilane PS1 which has at least one secondary or tertiary amino group. Suitable in a second embodiment is a polysilane PS2 which is obtainable from a reaction of aminosilane or mercaptosilane with a polyisocyanate or with a polyurethane polymer containing isocyanate groups.

The polysilane PS1 has at least one secondary or tertiary amino group, more particularly a secondary amino group. Particularly suitable are aminosilanes of the formula (III).

R⁴Si(OR⁵)₍₃₋ₐ₎(R⁶)ₐ]ₙ (III)

In this formula R⁴ is an n-valent organic radical having at least one secondary or tertiary amino group. R⁵ is independently at each occurrence an alkyl group having 1 to 4 C atoms or an acyl group having 1 to 4 C atoms. The index a stands for a value of 0, 1 or 2. Additionally R⁶ independently at each occurrence is H or is an alkyl group having 1 to 10 C atoms, and n stands for a value of 2, 3 or 4. With particular preference n stands for 2 or 3, i.e. preferably the polysilane PS1 contains 2 or 3 silane groups. Preference is given to polysilanes PS1 having 2 silane groups. Polysilanes PS1 with a=0 are preferred. Preferred as R⁵ are methyl, ethyl, propyl and butyl groups and also their positional isomers. With maximum preference R⁵ is a methyl group.

Preferred polysilanes PS1 are firstly polysilanes having the formula (IV).

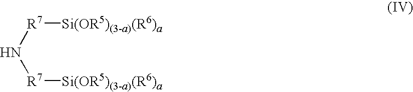

In this formula R⁷ is a linear or branched alkylene group having 1 to 6 C atoms, in particular a propylene group.

Particularly preferred polysilanes PS1 are bis(3-trimethoxysilylpropyl)amine and bis(3-triethoxysilylpropyl)amine. The most preferred polysilane PS1 is bis(3-trimethoxysilylpropyl)amine.

Preferred polysilanes PS1 are secondly polysilanes which contain at least one structural element of the formula (V) or (VI), in particular of the formula (V-1) or (VI-1).

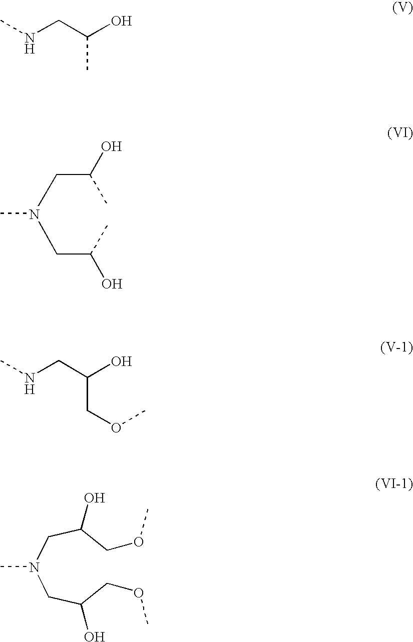

Polysilanes PS1 of this kind of the formula V and VI, and V-1 and VI-1, can be prepared via reactions of primary or secondary amines with epoxides, or with glycidyl ethers. The silane groups may come either from the amine or from the epoxide, or from the glycidyl ether.

Polysilanes PS1 of this kind are firstly, for example, the reaction products of 3-aminopropyltrimethoxysilane or bis(3-trimethoxysilylpropyl)amine with bisphenol A diglycidyl ether or hexanediol diglycidyl ether.

Polysilanes PS1 of this kind are secondly, for example, reaction products of an epoxysilane of the formula (VII) with an aminosilane of the formula (VIII).

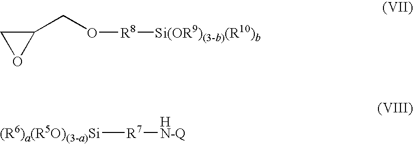

In these formulae R⁹ independently at each occurrence is an alkyl group having 1 to 4 C atoms or an acyl group having 1 to 4 C atoms. Preferably R⁹ is a methyl group. R¹⁰ independently at each occurrence is H or an alkyl group having 1 to 10 C atoms. R⁷ and R⁸ independently of one another are each a linear or branched alkylene group having 1 to 6 C atoms, especially propylene. Q is H or is an alkyl, cycloalkyl or aryl radical having 1 to 20 C atoms or a radical of the formula —(CH₂—CH₂—NH)_{d}H or is a radical of the formula —R⁷—Si(OR⁵)₍₃₋ₐ₎(R⁶)ₐ. The index b stands for a value of 0, 1 or 2, preferably 0. The index d stands for a value of 1 or 2.

R⁶, R⁵ and a have the definitions already described for formula (III).

Polysilanes PS1 of this kind may have a structure of the formula (IX).

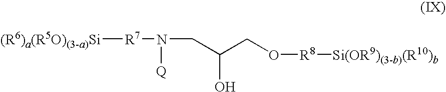

Particularly preferred as polysilane PS1 containing at least one secondary or tertiary amino group are reaction products of 3-aminopropyltrimethoxysilane or bis(3-trimethoxysilylpropyl)amine and 3-glycidyloxypropyltrimethoxysilane.

Particularly suitable polysilanes PS2 are polysilanes which are obtained from the reaction of at least one aminosilane or mercaptosilane of the formula (X) with at least one polyisocyanate or at least one polyurethane polymer containing isocyanate groups. Polysilanes PS2 of this kind have in particular the formula (XI).

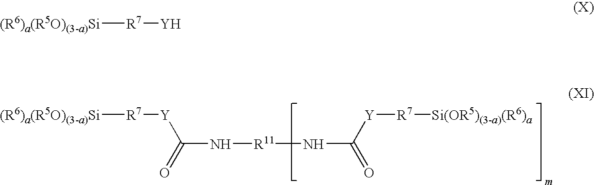

In these formulae Y is NQ or S. Additionally R¹¹ is a polyisocyanate or polyurethane polymer containing isocyanate groups following removal of m NCO groups, and m stands for a value of 1, 2 or 3, more particularly 1 or 2.

Particularly suitable aminosilanes of the formula (X) are aminosilanes having primary amino groups and selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyidimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyidimethoxymethylsilane and aminomethylmethoxydimethylsilane. 3-aminopropyltrimethoxysilane and 3-aminopropylmethyidimethoxysilane are preferred.

As aminosilanes of the formula (X) it is also possible, despite the fact that they are slower to react, to use aminosilanes having secondary amino groups. Particularly suitable are aminosilanes having secondary amino groups and selected from the group consisting of N-methyl-3-aminopropyltrimethoxysilane, N-ethyl-3-aminopropyltrimethoxysilane, N-butyl-3-aminopropyltrimethoxysilane, N-cyclohexyl-3-aminopropyltrimethoxysilane, N-phenyl-3-aminopropyltrimethoxysilane, N-methyl-3-amino-2-methylpropyltrimethoxysilane, N-ethyl-3-amino-2-methylpropyltrimethoxysilane; N-ethyl-3-aminopropyldimethoxymethylsilane, N-phenyl-4-aminobutyltrimethoxysilane, N-phenyl-aminomethyldimethoxymethylsilane, N-cyclohexylaminomethyldimethoxymethylsilane, N-methylaminomethyidimethoxymethylsilane, N-ethylaminomethyldimethoxymethylsilane, N-propylaminomethyldimethoxymethylsilane, N-butylaminomethyldimethoxymethylsilane; N-(2-aminoethyl)-3-aminopropyltrimethoxysilane, 3-[2-(2-aminoethylamino)ethylamino]propyltrimethoxysilane, N-(2-aminoethyl)-3-aminopropylmethyldimethoxysilane, 3-[2-(2-aminoethylamino)ethylamino]propylmethyldimethoxysilane, bis(3-trimethoxysilylpropyl)amine and bis(3-triethoxysilylpropyl)amine.

Preferred aminosilanes of the formula (X) with secondary amino groups are N-butyl-3-aminopropyltrimethoxysilane, N-methyl-3-aminopropyltrimethoxysilane, N-phenyl-3-aminopropyltrimethoxysilane or bis(3-trimethoxysilylpropyl)amine.

Particularly suitable mercaptosilanes of the formula (X) are the mercaptosilanes MS mentioned before.

Particularly suitable polyisocyanates are diisocyanates or triisocyanates. Preference is given to commercially available polyisocyanates, such as, for example, 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodecamethylene diisocyanate, lysine diisocyanate and lysine ester diisocyanate, cyclohexane 1,3- and 1,4-diisocyanate and any desired mixtures of these isomers, 1-isocyanato-3,3,5-trimethyl-5-isocyanatomethylcyclohexane (i.e. isophorone diisocyanate or IPDI), perhydro-2,4′- and -4,4′-diphenylmethane diisocyanate (HMDI), 1,4-diisocyanato-2,2,6-trimethylcyclohexane (TMCDI), 1,3- and 1,4-bis-(isocyanatomethyl)cyclohexane, m- and p-xylylene diisocyanate (m- and p-XDI), m- and p-tetramethyl-1,3- and -1,4-xylylene diisocyanate (m- and p-TMXDI), bis-(1-isocyanato-1-methylethyl)naphthalene, 2,4- and 2,6-tolylene diisocyanate and any desired mixtures of these isomers (TDI), 4,4′-, 2,4′- and 2,2′-diphenylmethane diisocyanate and any desired mixtures of these isomers (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatobiphenyl (TODI), and also any desired mixtures of the aforementioned isocyanates and their biurets or their isocyanurates. Particular preference is given to MDI, TDI, HDI and IPDI and their biurets or isocyanurates.

Polyurethane polymers containing isocyanate groups can be obtained in conventional manner in particular from the immediately aforementioned polyisocyanates and polyols and/or polyamines, as are disclosed in patent specification US 2006/0122352 A1 in paragraphs [0029] to [0041] and [0043] to [0044], whose content is hereby incorporated by reference.

A preferred polysilane PS is a polysilane of the formula (IV); most preferably the polysilane PS is a bis(3-trimethoxysilylpropyl)amine or bis(3-triethoxysilylpropyl)amine.

The reaction product present in the composition is obtained from a reaction mixture comprising at least one mercaptosilane MS, at least one polysilane PS and at least one epoxy resin EP. Since the reactions that take place are in some cases highly complex, it is difficult to specify the structures formed precisely in the reaction mixture. These reactions typically give rise to structural elements of the formula (XII) and (XIII).

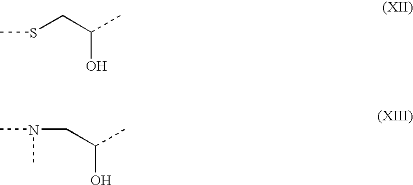

These structural elements of the formulae (XII) and (XIII) may also be present simultaneously.

The ratio of the number of epoxide groups used in the reaction mixture to the sum of the number of mercapto groups and amino groups used in the reaction mixture is preferably ≦1.

Furthermore, the ratio of the number of silane groups of the mercaptosilanes MS used in the reaction mixture to the number of silane groups of the polysilane PS used in the reaction mixture is from 0.05-5, in particular from 0.1-2, preferably from 0.2-1.

Furthermore, the molar ratio of all of the mercaptosilanes MS used in the reaction mixture to all of the polysilanes PS used in the reaction mixture is from 0.1-10, in particular from 0.3-5, preferably from 0.5-2.

The composition may further comprise at least one adhesion promoter, more particularly at least one silane or at least one organotitanium compound.

A suitable silane adhesion promoter is typically an aminosilane AS which contains at least one primary or secondary amino group.

The aminosilane AS which contains at least one primary or secondary amino group comprises, in particular, primary or secondary aminosilanes as already mentioned above as suitable aminosilanes of the formula (X).

Additionally suitable as adhesion promoters are aminosilanes containing tertiary amino groups, for example tris-[3-(trimethoxysilyl)propyl]amine or tris-[3-(triethoxysilyl)propyl]amine.

Further-preferred aminosilane adhesion promoters are N-(2-aminoethyl)-3-aminopropyltrimethoxysilane and bis(3-trimethoxysilylpropyl)amine.

Additionally, epoxysilanes, (meth)acrylatosilanes or alkylsilanes or vinylsilanes, especially 3-glycidyloxypropyltrimethoxysilane, 3-glycidyloxypropyltriethoxysilane, 3-(meth)acryloyloxypropyltriethoxysilane, 3-(meth)acryloyloxypropyltrimethoxysilane, vinyltrimethoxysilane and vinyltriethoxysilane, can be used as adhesion promoters.

The organotitanium compound as adhesion promoter in this case contains at least one substituent attached to the titanium atom via an oxygen-titanium bond.

Particularly suitable substituents attached to the titanium atom via an oxygen-titanium bond are those substituents selected from the group consisting of alkoxy group, sulphonate group, carboxylate group, dialkyl phosphate group, dialkyl pyrophosphate group and acetylacetonate group.

Particularly suitable compounds are those in which all of the substituents attached to the titanium are selected from the group consisting of alkoxy group, sulphonate group, carboxylate group, dialkyl phosphate group, dialkyl pyrophosphate group and acetylacetonate group, it being possible for all of the substituents to be identical or different from one another.

Alkoxy groups which have proved to be particularly suitable are, in particular, those known as neoalkoxy substituents, particularly of the following formula (XIV).

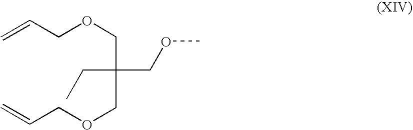

Sulphonic acids which have proved to be particularly suitable are, in particular, aromatic sulphonic acids whose aromatic moieties are substituted by an alkyl group. Considered preferred sulphonic acids are radicals of the following formula (XV).

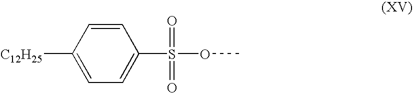

Having proved to be particularly suitable as carboxylate groups are, in particular, carboxylates of fatty acids. Decanoate is considered a preferred carboxylate.

Organotitanium compounds are available commercially, for example from the company Kenrich Petrochemicals or DuPont. Examples of suitable organotitanium compounds are, for example, Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA 01, LICA 09, LICA 12, LICA 38, LICA 44, LICA 97, LICA 99, KR OPPR, KR OPP2 from Kenrich Petrochemicals or Tyzor® ET, TBT, TOT TPT, NPT, BTM, AA, M-75, M-95, AA-105, TE, ETAM, OGT from DuPont.

Considered preferred are Ken-React® KR 7, KR 9S, KR 12, KR 26S, KR 38S, KR44, LICA 09, LICA 44, NZ 44, and also Tyzor® ET, TBT, TOT, TPT, NPT, BTM, AA, AA-75, M-95, AA-105, TE, ETAM, OGT from DuPont. Particular preference is given to Tyzor® TBT and Tyzor® OGT.

It is clear to the person skilled in the art that, under the influence of water, these organotitanium compounds undergo hydrolysis and form OH groups attached to the Ti atom. Hydrolysed or partly hydrolysed organotitanium compounds of this kind are then able to undergo further condensation and to form condensation products which contain Ti—O—Ti bonds. Where silanes and/or titanates are mixed as adhesion promoters, mixed condensation products as well are possible, containing Si—O—Ti bonds. A small fraction of condensation products of this kind is possible, particularly if they are soluble, emulsifiable or dispersible.

The composition typically comprises at least one silane or organotitanium compound as adhesion promoter, more particularly in an amount of 0.1%-10% by weight, preferably of 1%-5% by weight, based on the weight of the composition.

It has proved to be advantageous for the composition to comprise at least one solvent, more particularly at least one organic solvent. Suitable such organic solvents include, in particular, hydrocarbons or ketones or carboxylic esters or alcohols. Preferred examples of such are toluene, xylene, hexane, heptane, methyl ethyl ketone, acetone, butyl acetate, ethyl acetate, ethanol, isopropanol, methanol. Particular preference is given to hexane, heptane, methyl ethyl ketone, acetone, butyl acetate, ethyl acetate, ethanol, isopropanol, methanol.

Moreover, there are specific embodiments in which water is a suitable solvent as well, if need be in a blend with an organic solvent.

The solvent is used in particular in an amount of 40%-99% by weight, more particularly of 60%-95% by weight, based on the weight of the composition.

The composition may if desired contain further constituents. Such further constituents ought not, however, to impair the storage stability of the composition. Further constituents are, for example, catalysts, luminescent indicators such as Uvitex® OB from Ciba Specialty Chemicals, stabilizers, surfactants, acids, dyes and pigments.

The composition preferably comprises or consists of an epoxy resin EP, more particularly a solid epoxy resin of the formula (I), in an amount of 2%-10% by weight, based on the total weight of the composition, and a mercaptosilane MS, more particularly 3-mercaptopropyltrimethoxysilane, in an amount of 1%-10% by weight, based on the total weight of the composition, and a polysilane PS, more particularly bis(3-trimethoxysilylpropyl)amine, in an amount of 1%-10% by weight, based on the total weight of the composition, and a solvent, more particularly ethyl acetate, in an amount of 60%-95% by weight, based on the total weight of the composition.

The composition is outstandingly suitable as an adhesion promoter and can be used widely. In particular it can be used as a primer or constituent of a primer. A primer is an undercoat which is applied to a surface and, after a certain waiting time after application, known as the flash-off time, is covered over with an adhesive or sealant or with a coating, and which serves to improve the adhesion of the adhesive or sealant or coating to the substrate surface in question.

The composition is therefore suitable for use as an adhesion primer for a substrate S1; the substrate S1 is more particularly glass or glass ceramic.

The composition can also be used, however, as an adhesion promoter in an adhesive or sealant or coating. Its use in an adhesive or sealant is particularly appropriate.

For the application of the composition as an adhesion promoter there are various possibilities of use:

In a first method of adhesive bonding or sealing two substrates S1 and S2, the method comprises at least the following steps:
a) applying a composition as described above to a first substrate S1
b) applying an adhesive or sealant to the flashed-off composition applied as per step a)
c) contacting the adhesive or sealant with a second substrate S2.

In a second method of adhesive bonding or sealing of two substrates S1 and S2, the method comprises at least the following steps:
a′) applying a composition as described above to a first substrate S1
b′) applying an adhesive or sealant to the surface of a second substrate S2
c′) contacting the adhesive or sealant with the flashed-off composition located on the substrate S1.

In a third method of adhesive bonding or sealing of two substrates S1 and S2, the method comprises at least the following steps:
a″) applying a composition as described above to a first substrate S1
b″) applying an adhesive or sealant to the first substrate S1 and second substrate S2, to which at least one thereof as per step a″) a composition has been applied
c″) contacting the applied adhesives or sealants with one another while assembling the substrate parts to form an adhesively bonded assembly or sealed assembly.

In a fourth method of adhesive bonding or sealing of two substrates S1 and S2, the method comprises at least the following steps:
a′″) applying a composition as described above to a first substrate S1
b′″) flashing off the composition
c′″) applying adhesive or sealant between the surfaces of the substrates S1 and S2.

In all of these four possibilities, the second substrate S2 is composed of the same or different material to the substrate S1.

Step c), c′), c″) or c′″) is typically followed by a step of curing of the adhesivable sealant. The person skilled in the art understands that, depending on the system used and the reactivity of the adhesive, crosslinking reactions, and hence the curing itself, may begin as early as during application. The main part of the crosslinking and hence, in the narrower sense of the term, the curing, however, takes place after application; indeed, otherwise there are also problems with the development of adhesion to the substrate surface.

In particular at least one of the substrates, S1 or S2, is glass or glass ceramic. More particularly one substrate is glass or glass ceramic and the other substrate is a coating or a coated metal or a coated metal alloy. Accordingly the substrate S1 or S2, respectively, is glass or glass ceramic and the substrate S2 or S1, respectively, is a coating or a coated metal or a coated metal alloy.

Adhesives or sealants may be one- or two-component adhesives or sealants.

Suitable one-component adhesives or sealants comprise, in particular, moisture-curing, isocyanate group-terminated polymers. Such adhesives or sealants crosslink under the influence of water, especially of atmospheric moisture. Examples of such one-component moisture-curing polyurethane adhesives are those from the SikaFlex® and SikaTack® product lines as available commercially from Sika Schweiz AG.

The abovementioned isocyanate-terminated polymers are prepared from polyols, especially polyoxyalkylene polyols, and polyisocyanates, especially diisocyanates.

Suitable two-component adhesives or sealants are two-component polyurethane adhesives or sealants whose first component comprises an amine or a polyol and whose second component comprises an NCO-containing polymer or a polyisocyanate. Examples of such two-component, room temperature-curing polyurethane adhesives are those from the SikaForce® product line as available commercially from Sika Schweiz AG.

It has emerged that particularly in the case of moisture-curing polyurethane adhesives or sealants it is possible to achieve a sharp improvement in adhesion, particularly on glass and glass ceramics, and especially after water storage, using the composition described.

These adhesive bonding and sealing methods find application more particularly in the production of articles, especially of means of transport. Such articles are, in particular, cars, buses, lorries, rail vehicles, boats or aircraft.

The most preferred application is the glazing of means of transport, especially of road and rail vehicles.

### EXAMPLES

Different compositions were prepared that consisted of the ingredients in parts by weight as per the details in Table 1. The compositions Ref1, Ref2 and Ref3 are comparative examples.

Raw Materials Used:

| | |
|---|---|
| A189 | 3-Mercaptopropyltrimethoxysilane |
| | Silquest ® A189, GE Silicones, Switzerland |
| A1170 | Bis(trimethoxysilylpropyl)amine |
| | Silquest ® A1170, GE Silicones, Switzerland |
| NPAPTS | N-phenyl-3-aminopropyltrimethoxysilane, |
| | Sigma-Aldrich Chemie GmbH, Switzerland |
| GT 7071 | Araldite ® GT 7071, |
| | Huntsman International, LLC, USA |

Preparation of the Compositions

Following the amounts in Table 1 for the compositions, the solvents 5 together with the further ingredients where present were mixed at 23° C. in the absence of atmospheric moisture. The solid epoxy resin Aralditee GT 7071 was dissolved in 1 part of ethyl acetate per 3 parts of Araldite® GT 7071 prior to addition to a composition, and the composition was mixed on a roller bed for 12 hours.

TABLE 1
Ingredients of the compositions in parts by weight.

| Ingredients | 1 | 2 | 3 | 4 | 5 | Ref1 | Ref2 | Ref3 |
|---|---|---|---|---|---|---|---|---|
| A-189 | 1.4 | 1 | 0.6 | 1.4 | 1.4 | 1.4 | 1.4 | 1.4 |
| A-1170 | 3.5 | 2.6 | 1.5 | 3.5 | 3.5 | 3.5 | 3.5 | — |
| NPAPTS | — | — | — | — | 0.4 | — | — | — |
| GT 7071 | 3.6 | 2.6 | 1.6 | 3.6 | 3.6 | — | — | 3.6 |
| Ethyl acetate | 61.5 | 63.8 | 66.3 | 1.2 | 61.1 | — | 65.1 | 65 |
| Methyl ethyl | — | — | — | 60.3 | — | — | — | — |
| ketone | | | | | | | | |
| Heptane | — | — | — | — | — | 65.1 | — | — |
| Total | 70 | 70 | 70 | 70 | 70 | 70 | 70 | 70 |

Test Methods

Application and Curing

For the experiments in Tables 2 and 3, the compositions were each applied to the substrate in a “wipe on/off” procedure using a wipe (Tela®, Tela-Kimberly Switzerland GmbH).

The substrates used were as follows:
Glass ceramic, back light of a Mercedes Benz, Daimler AG, S Class, BR 221, PPG, (Sub1),
Glass ceramic, back light of a Mercedes Benz, Daimler AG, E Class, BR 211, PPG, (Sub2).
Glass ceramic, back light of a Mercedes Benz, Daimler AG, E Class, Kombi BR 211, PPG, (Sub3),
Glass ceramic, back light of a Mercedes Benz, Daimler AG, C Class, BR 203, PPG, (Sub4).
Standard sheet glass, Sn side, Rocholl GmbH, Germany, (Glass).

After a flash-off time of 10 minutes, the adhesives were applied in the form of a circular bead, using a cartridge press and a nozzle, to the substrate surface coated with composition. The adhesive temperature on application was 60° C.

The adhesives used were the one-component polyurethane adhesives Sikaflex® 250 DM-2 (DM2), or Sikaflex® 250 DM-3 (DM3), or Sikaflex® 250 DM-5 (DM5) which are available commercially from Sika Schweiz AG.

In Table 3, 2 per cent by volume of Sika® Booster Paste (Sika Schweiz AG) were mixed homogeneously into Sikaflex® 250 DM-5 (DM5B).

Subsequently the adhesive was cured for 7 days at 23° C. and 50% relative humidity (room-temperature conditions storage: CL) and a third of the bead was tested by the adhesion test described below. Thereafter the sample was placed in water at 23° C. for a further 7 days (water storage: WS). Subsequently the adhesion was tested by the bead test for a further third of the bead. After that the substrates were exposed to heat-and-humidity conditions of 100% relative humidity and 70° C. (HS), and the adhesion of the last third of the bead was then determined.

Adhesion Test (Bead Test)

The adhesion of the adhesive was tested by means of the bead test. In this test, an incision is made at the end of the bead just above the bond face. The incised end of the bead is held with round-end tweezers and pulled from the substrate. This is done by carefully rolling the bead up onto the tip of the tweezers, and by placing a cut down to the bear substrate perpendicularly to the bead-pulling direction. The bead-pulling speed is chosen such that a cut has to be made about every 3 seconds. The test distance must be at least 8 cm. An assessment is made of the adhesive that remains on the substrate after the bead has been pulled off (cohesive fracture). The adhesion properties are evaluated by estimating the cohesive component of the adhesion area:

1=>95% cohesive fracture

2=76-95% cohesive fracture

3=25-75% cohesive fracture

4=<25% cohesive fracture

5=0% cohesive fracture (purely adhesive fracture).

TABLE 2
Adhesion results after different forms of storage.

| | | 1 | | | 2 | | | 3 | | | 4 | | |
|---|---|---|---|---|---|---|---|---|---|---|---|---|---|
| Substrate | Adhesive | CS | WS | HS | KL | WS | HS | CS | WS | HS | CS | WS | HS |
| Sub1 | DM2 | 1 | 1 | 1 | 2 | 3 | 1 | 1 | 3 | 1 | 1 | 1 | 1 |
| | DM5 | 1 | 1 | 1 | 1 | 1 | 1 | 1 | 2 | 1 | 1 | 1 | 1 |
| | | 5 | | | Ref1 | | | Ref2 | | | Ref3 | | |
| Substrate | Adhesive | CS | WS | HS | CS | WS | HS | CS | WS | HS | CS | WS | HS |
| Sub1 | DM2 | 3 | 3 | 1 | 3 | 5 | 2 | 3 | 4 | 5 | 5 | 5 | 5 |
| | DM5 | 1 | 1 | 1 | 2 | 4 | 1 | 1 | 3 | 1 | 5 | 5 | 5 |

TABLE 3
Adhesion results after different forms of
storage

| | | 1 | | | Ref1 | | |
|---|---|---|---|---|---|---|---|
| Substrate | Adhesive | CS | WS | HS | CS | WS | HS |
| Sub2 | DM3 | 1 | 2 | 1 | 1 | 4 | 1 |
| | DM5B | 1 | 2 | 1 | 4 | 5 | 1 |
| Sub3 | DM3 | 1 | 1 | 2 | 2 | 3 | 1 |
| | DM5B | 1 | 1 | 1 | 4 | 4 | 1 |
| Sub4 | DM2 | 1 | 1 | 1 | 1 | 3 | 1 |
| Glass | DM2 | 1 | 1 | 1 | 2 | 3 | 1 |

1. Composition comprising at least one reaction product obtained from a reaction mixture comprising
i) at least one mercaptosilane MS;
and
ii) at least one polysilane PS;
and
iii) at least one epoxy resin EP.

2. Composition according to claim 1, wherein the polysilane PS has at least one secondary or tertiary amino group.

3. Composition according to claim 1, wherein the epoxy resin EP has an epoxide equivalent weight (EEW) of 300 g/eq-2000 g/eq.

4. Composition according to claim 1, wherein the weight fraction of the epoxy resin EP used in the reaction mixture is 15%-70% by weight, based on the weight of the reaction mixture.

5. Composition according to claim 1, further comprising at least one solvent in an amount of 40%-99% by weight based on the weight of the composition.

6. Composition according to claim 1, further comprising at least one silane or at least one organotitanium compound as adhesion promoter, in an amount of 0.1%-10% by weight based on the weight of the composition.

7. Composition according to claim 1, wherein the ratio of the number of epoxide groups used in the reaction mixture to the sum of the number of mercapto groups and amino groups used in the reaction mixture is ≦1.

8. Composition according to claim 1, wherein the molar ratio of all of the mercaptosilanes MS used in the reaction mixture to all of the polysilanes PS used in the reaction mixture is from 0.1-10.

9. An adhesion undercoat for a substrate S1, comprising:
the composition according to claim 1.

10. The adhesion undercoat according to claim 9, wherein the substrate S1 is glass or glass ceramic.

11. Method of adhesively bonding or sealing two substrates S1 and S2 which comprises at least the following steps:
a) applying a composition according to claim 1 to a first substrate S1;
b) applying an adhesive or sealant to the flashed-off composition applied as per step a);
c) contacting the adhesive or sealant with a second substrate S2; or
a′) applying a composition according to claim 1 to a first substrate S1;
b′) applying an adhesive or sealant to the surface of a second substrate S2;
c′) contacting the adhesive or sealant with the flashed-off composition located on the substrate S1;
or
a″) applying a composition according to claim 1 to a first substrate S1;
b″) applying an adhesive or sealant to the first substrate S1 and second substrate S2, to which at least one thereof as per step a″) a composition has been applied;
c″) contacting the applied adhesives or sealants with one another while assembling the substrate parts to form an adhesively bonded assembly or sealed assembly; or
a′″) applying a composition according to claim 1 to a first substrate S1;
b′″) flashing off the composition;
c′″) applying adhesive or sealant between the surfaces of the substrates S1 and S2;
the second substrate S2 being composed of the same or different material to the substrate S1.

12. Method according to claim 11, wherein at least one of the substrates, S1 or S2, is glass or glass ceramic.

13. Method according to claim 11, wherein the substrate S1, or S2, is glass or glass ceramic and in that the substrate S2, or S1, respectively, is a coating material or a coated metal or a coated metal alloy.

14. Article produced by a method according to claim 1.

15. Article according to claim 14, wherein the article is a means of transport.
